(19) United States
(12) Patent Application Publication
(10) Pub. No.: US 2004/0016611 A1
(43) Pub. Date: Jan. 29, 2004

(54) Brake disk

(75) Inventors: Heinrich Hofmann, Schweinfurt (DE); Jens Heim, Schweinfurt (DE); Peter Niebling, Bad Kissingen (DE); Roland Langer, Schwanfeld (DE)

Correspondence Address: OSTROLENK FABER GERB & SOFFEN, 1180 AVENUE OF THE AMERICAS, NEW YORK, NY, 100368403

(73) Assignee: FAG Kugelfischer Georg Schafer AG

(21) Appl. No.: 10/602,311

(22) Filed: Jun. 24, 2003

(30) Foreign Application Priority Data
Jun. 25, 2002 (DE) 102 28 416.4

(51) Int. Cl. F16D 65/10

(52) U.S. Cl. 188/218 XL

(57) ABSTRACT

Brake disk having a pot-shaped central fastening area. Reinforcing elements in the pot-shaped fastening area are disposed next to through holes in the area, for ensuring that deformations in the pot-shaped area caused by bolting fast the wheel rim do not have the effect of axial runout in the brake disk.

### FIELD OF THE INVENTION

The invention relates to the configuration of a brake disk.

### BACKGROUND OF THE INVENTION

In motor vehicles, the problem of brake squeal or brake judder has been known for a long time. Many different approaches have been adopted thus far to solve this problem. The problem of brake squeal manifests itself in the occurrence during the braking process of vibrations associated with noise generation, which are harmful and are felt to be unpleasant. Studies in which the elastic deformation of the brake disk has been measured in order in this way to trace the cause of brake squeal have shown that the tightening torque of the bolts used to fasten the rim has an effect on the axial runout of the brake disk. When fastening the rim on the wheel bearing, the fastening bolts are passed through the pot-shaped area of the brake disk and screwed into a thread in the rotating part of the wheel bearing. While the bolts are being fastened, the rim is supported on the pot-shaped fastening area of the brake disk and, as a result, deforms this area elastically and, in part, also plastically. These deformations lead to axial runout in the brake disk. Since in practice the bolts are often tightened to different extents, the axial forces acting on the pot-shaped fastening area of the brake disk are of different magnitudes and thus lead to different axial runouts in the brake disk. These elastic deformations of the brake disk lead to brake squeal.

### OBJECT OF THE INVENTION

It is thus the object to configure a brake disk with a pot-shaped fastening part in such a way that the loads on the rim due to the bolt forces during the fastening of the rim have virtually no effect on the true running of the brake disk.

### DESCRIPTION OF THE INVENTION

This object is achieved by the invention, comprising reinforcement or axial offsets in the pot-shaped area of, and adjacent through holes through, the pot-shaped area of the brake disk.

The essence of the invention comprises stabilizing the pot-shaped fastening area of the brake disk in the axial direction. One technique to reinforce the pot-shaped fastening area of the brake disk is by means of axially offset areas of the pot-shaped area. A further advantage is that the brake disk is also lighter.

### BRIEF DESCRIPTION OF THE DRAWINGS

FIG. 1 shows an oblique, three-dimensional and fragmentary representation of a brake disk with pot-shaped fastening areas and reinforcing ribs.

FIG. 2 shows an oblique, three-dimensional representation of a brake disk with axially offset sections.

FIG. 3 shows an oblique, cross-sectional and fragmentary view of a brake disk according to the invention and a wheel bearing.

FIG. 4 shows a section through the wheel bearing, the brake disk and the rim.

### DETAILED DESCRIPTION OF THE DRAWINGS

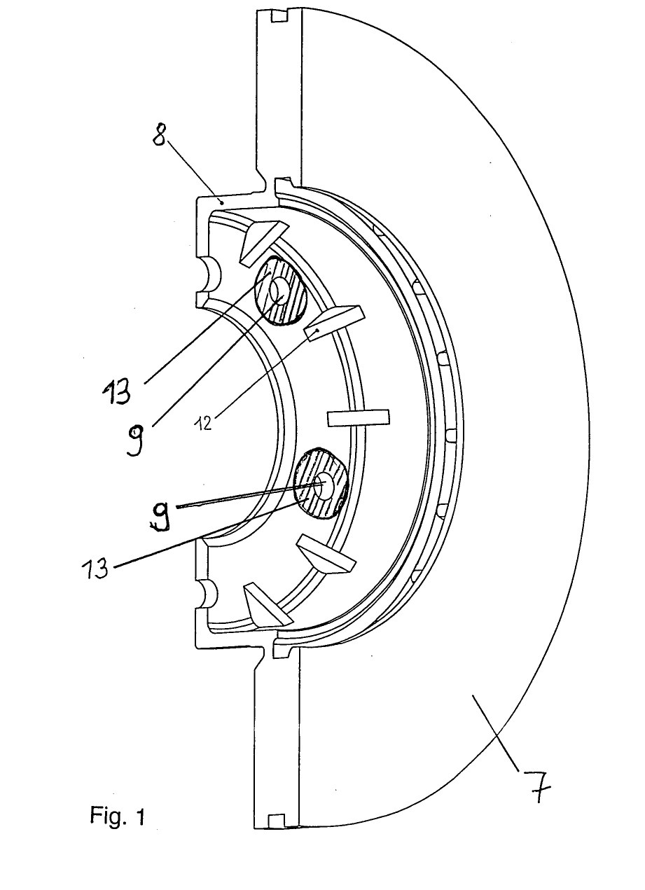

A pot-shaped area 8 of a brake disk with reinforcing ribs 12 is shown in FIG. 1. In this exemplary embodiment, the reinforcing ribs 12 are disposed radially to the inside of the pot-shaped area 8. An alternate arrangement of the reinforcing ribs radially to the outside of the pot-shaped area is possible, but not illustrated. The zone 13 around the through hole 9 in the pot-shaped area of the brake disk is elastically and, in part, also plastically deformed by the supporting forces of the bolted-on rim. These deformations have an effect on the true running of the brake disk 7.

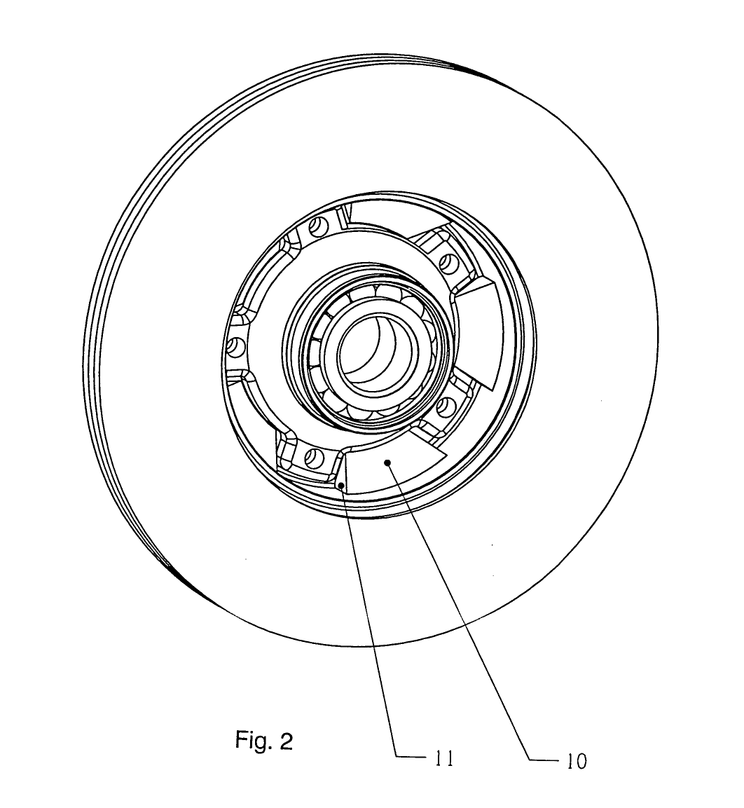

The configuration of the reinforcing surfaces 10 in an axially offset arrangement is shown clearly in FIG. 2. The reinforcing webs 11, which are preferably formed perpendicularly to the pot-shaped surfaces, have a particularly great effect in increasing stiffness in the pot-shaped area.

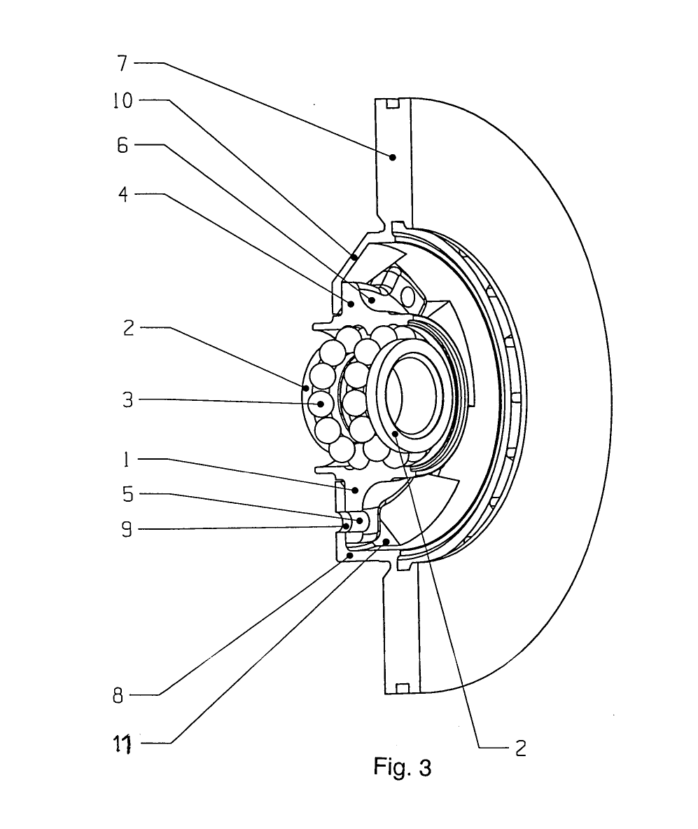

FIG. 3 shows a wheel bearing unit 1 with inner races 2, two rows of rolling contact elements 3 and the rotating part of the wheel bearing unit with fastening flange 4. The holes with thread 5 for fastening the bolts are provided in the rotating part of the wheel bearing flange. Recesses 6 are provided between the fastening openings 5. The disk brake 7 with the pot-shaped fastening area 8 is illustrated. In the area of the through hole 9, the pot-shaped area of the brake disk is embodied without reinforcing elements. Between the through holes 9, the pot-shaped area 8 of the brake disk 7 is embodied with reinforcing webs 10. The reinforcing webs are in a truss-like or trapezoidal arrangement.

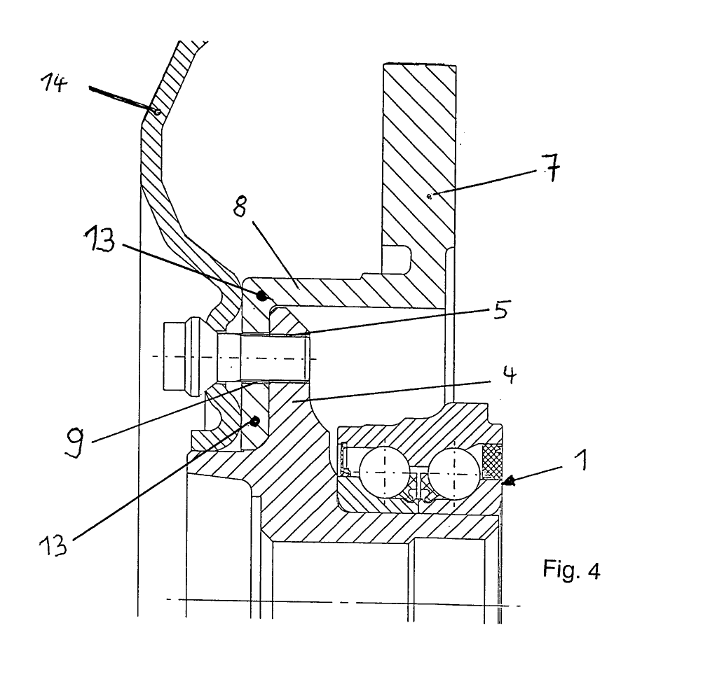

FIG. 4 shows the wheel bearing 1, the brake disk 7 with the pot-shaped area 8 and a wheel rim 14 in section. The elastically and, in part, plastically deformed area 13 around the bolt is shown, which arises owing to the supporting forces of the rim 14 on the pot-shaped area of the brake disk.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A brake disk comprising
an annular disk area and a pot-shaped fastening area radially inward on the brake disk; a plurality of through holes through the pot-shaped area around the disk; and
at least one of reinforcing elements and axially offset oblique sections disposed in the pot-shaped fastening area of the brake disk and next to the through holes.

2. The brake disk of claim 1, wherein the axially offset oblique sections of the pot-shaped area of the brake disk include reinforcing webs perpendicular to a pot surface of the fastening area.

3. The brake disk of claim 1, wherein the reinforcing ribs are disposed in the pot-shaped area of the brake disk.

4. In combination, the brake disk of claim 1, and a wheel bearing having a rotatable flange component, wherein the brake disk is connected with the rotatable flange component of the wheel bearing and with a rim of a wheel having the wheel bearing.

5. The combination of claim 4, further comprising bolt holes in the pot-shaped area of the brake disk for enabling bolting of the brake disk to the wheel rim.
